(19) United States
(12) Patent Application Publication
(10) Pub. No.: US 2022/0410281 A1
(43) Pub. Date: Dec. 29, 2022

(54) ABRASIVE ROTARY TOOL WITH EXPANDABLE COLLET

(71) Applicant: 3M INNOVATIVE PROPERTIES COMPANY, St. Paul, MN (US)

(72) Inventors: Bruce A. SVENTEK, Woodbury, MN (US); Stephen C. LOPER, Eden Prairie, MN (US)

(21) Appl. No.: 17/624,296

(22) PCT Filed: Jun. 29, 2020
(86) PCT No.: PCT/IB2020/056132

§ 371 Date: Dec. 31, 2021

Related U.S. Application Data
(60) Provisional application No. 62/870,147, filed on Jul. 3, 2019.

(51) Int. Cl. B23B 31/20; B23B 31/40; B24B 45/00

(52) U.S. Cl. CPC B23B 31/2025; B23B 31/4013; B24B 45/00; B23B 2226/33; B23B 2231/2013; B23B 2231/2016; B23B 2231/2037

(57) ABSTRACT

The disclosure is generally directed to abrasive rotary tools capable of expanding into a substrate. Exemplary abrasive rotary tools include an expandable collet configured to expand an abrasive surface of the abrasive rotary tool. The expandable collet may be positioned proximate to a multi-planar edge of a substrate, such as a hole, and expanded into the edge to more fully and/or evenly contact the edge of the substrate. In this way, an abrasive rotary tool may more quickly and/or consistently abrade the edge.

### TECHNICAL FIELD

The invention relates to abrasive rotary tools.

### BACKGROUND

Handheld electronics, such as touchscreen smartphones and tablets, often include a cover glass to provide durability and optical clarity for the devices. Production of cover glasses may use computer numerical control (CNC) machining for consistency of features in each cover glass and high-volume production. The edge finishing of the perimeter of a cover glass and various other features, such as a hole, is important for strength and cosmetic appearance. Typically, diamond abrasive tools, such as metal bonded diamond tools, are used to machine the cover glasses. These tools may last a relatively long time and may be effective at high cutting rates. However, the tools may leave microcracks in the cover glass that become stress concentration points, which may significantly reduce the strength of the glass. To improve the strength or appearance of the cover glasses, the edges may be polished. For example, a polishing slurry, such as cerium oxide, is typically used to polish the glass covers. However, slurry-based polishing may be slow and require multiple polishing steps. Additionally, slurry polishing equipment may be large, expensive, and unique to particular features being polished. Overall, the slurry polishing systems themselves may produce low yields, create rounded corners of the substrate being abraded, and increase labor requirements.

### SUMMARY

The disclosure is generally directed to abrasive rotary tools capable of expanding into a substrate. Exemplary abrasive rotary tools include an expandable collet configured to expand an abrasive surface of the abrasive rotary tool. The expandable collet may be positioned proximate to a multi-planar edge of a substrate, such as a hole, and expanded into the edge to more fully and/or evenly contact the edge of the substrate. In this way, an abrasive rotary tool may more quickly and/or consistently abrade the edge.

In one embodiment, an abrasive article includes an expandable collet and an abrasive layer. The expandable collet has an interior surface and an exterior surface defining a longitudinal axis. The expandable collet has an unexpanded position and an expanded position. The interior surface defines an interior opening having a widest width dimension, Di, when the expandable collet in the unexpanded position. The abrasive layer has a working surface and an opposed surface. The opposed surface of the abrasive assembly is adjacent the exterior surface of the expandable collet.

In another embodiment, an abrasive rotary tool includes the abrasive article described above and a rod. The rod is capable of urging the expandable collet into the expanded position. The rod has a widest width dimension, Dr, such that Dr >Di. The rod is positioned in the interior opening of the expandable collet.

In another embodiment, an assembly includes a computer-controlled machining system that includes a computer controlled rotary tool holder and a substrate platform, a substrate secured to the substrate platform, and an abrasive rotary tool as described above.

In another embodiment, a method for polishing a substrate includes providing an abrasive article according to abrasive article described above, in which the expandable collet is in the unexpanded position. The method further includes providing a substrate having at least one hole. A first substrate edge defines the circumference of the at least one hole. The method includes positioning the abrasive article into the at least one hole and expanding the expandable collet such that the working surface of the abrasive article contacts the first substrate edge. The method further includes rotating the abrasive article around the longitudinal axis, thereby abrading the first substrate edge.

The details of one or more embodiments of the disclosure are set forth in the accompanying drawings and the description below. Other features, objects, and advantages of the invention will be apparent from the description and drawings, and from the claims.

### BRIEF DESCRIPTION OF DRAWINGS

Like symbols in the drawings indicate like elements. Dotted lines indicate optional or functional components, while dashed lines indicate components out of view.

FIG. 1A is a side-view diagram that illustrates an assembly for abrading a substrate.

FIG. 1B is a side view cross-sectional diagram that illustrates an abrasive rotary tool that includes an expandable collet for expanding an abrasive surface.

FIG. 2A is a side view cross-sectional diagram that illustrates an abrasive rotary tool that includes an expandable collet in an unexpanded position.

FIG. 2B is a top view cross-sectional diagram that illustrates the abrasive rotary tool of FIG. 2A that includes an expandable collet in an unexpanded position.

FIG. 2C is a side view cross-sectional diagram that illustrates an abrasive rotary tool that includes an expandable collet in an expanded position.

FIG. 2D is a top view cross-sectional diagram that illustrates the abrasive rotary tool of FIG. 2C that includes an expandable collet in an expanded position.

FIG. 3A is a side view diagram that illustrates an expandable collet with alternating segments.

FIG. 3B is a side view diagram that illustrates an expandable collet with alternating segments and open joints.

FIG. 3C is a side view diagram that illustrates an expandable collet with a plurality of arms.

FIG. 3D is a side view diagram that illustrates an expandable collet with a plurality of tapered arms.

FIG. 4A is a side view cross-sectional diagram that illustrates an abrasive rotary tool that includes an expandable collet in an unexpanded position.

FIG. 4B is a side view cross-sectional diagram that illustrates an abrasive rotary tool that includes an expandable collet in an expanded position around a rod with a limiting structure.

FIG. 4C is a side view cross-sectional diagram that illustrates an abrasive rotary tool that includes an expandable collet with a positioning structure in an unexpanded position.

FIG. 4D is a side view cross-sectional diagram that illustrates an abrasive rotary tool that includes an expandable collet in an expanded position around a rod with a positioning structure.

FIG. 5A is a bottom view diagram that illustrates an expandable collet having a square cross-sectional shape.

FIG. 5B is a bottom view diagram that illustrates an expandable collet having a circle cross-sectional shape.

FIG. 5C is a bottom view diagram that illustrates an expandable collet having a hexagon cross-sectional shape.

FIG. 6 is diagram of a cover glass for an electronic device such as a cellular phone, personal music player, or other electronic device.

FIG. 7 is a flowchart illustrating exemplary techniques for abrading a substrate.

FIG. 8A is a side view cross-sectional diagram that illustrates an abrasive rotary tool that includes an expandable collet in a first expanded position.

FIG. 8B is a side view cross-sectional diagram that illustrates an abrasive rotary tool that includes an expandable collet in a second expanded position.

FIG. 9A is a side view diagram of a rod for an abrasive rotary tool that includes an expandable collet.

FIG. 9B is a perspective view diagram that illustrates the rod of FIG. 9A.

FIG. 9C is a perspective view diagram that illustrates the rod of FIG. 9A.

FIG. 10A is a side view diagram that illustrates an expandable collet.

FIG. 10B is a perspective view diagram that illustrates the expandable collet of FIG. 10A.

FIG. 10C is a perspective view diagram that illustrates the expandable collet of FIG. 10A.

FIG. 10D is a top view diagram that illustrates the expandable collet of FIG. 10A.

FIG. 10E is a bottom view diagram that illustrates the expandable collet of FIG. 10A.

FIG. 11A is a perspective view diagram that illustrates a rod for an abrasive rotary tool that includes an expandable collet.

FIG. 11B is a perspective view diagram that illustrates the expandable collet for receiving the rod of FIG. 11A.

FIG. 11C is a perspective diagram of the expandable collet of FIG. 11B that includes an abrasive layer.

FIG. 12A is a perspective view diagram that illustrates a rod for an abrasive rotary tool that includes an expandable collet.

FIG. 12B is a perspective view diagram that illustrates the expandable collet for receiving the rod of FIG. 12A.

FIG. 13A is a perspective view diagram that illustrates a rod for an abrasive rotary tool that includes an expandable collet.

FIG. 13B is a perspective view diagram that illustrates the expandable collet for receiving the rod of FIG. 13A.

FIG. 14A is a side view diagram that illustrates a rod for an abrasive rotary tool for an expandable collet.

FIG. 14B is a perspective view diagram that illustrates a rod for an abrasive rotary tool for an expandable collet.

FIG. 15A is a perspective view diagram that illustrates a rod for an abrasive rotary tool for an expandable collet.

FIG. 15B is a perspective view diagram that illustrates the expandable collet with an abrasive layer for receiving the rod of FIG. 15A.

FIG. 16A is a side view diagram that illustrates an expandable collet.

FIG. 16B is a perspective view diagram that illustrates the expandable collet of FIG. 16A.

FIG. 16C is a perspective view diagram that illustrates the expandable collet of FIG. 16A.

FIG. 16D is a top view diagram that illustrates the expandable collet of FIG. 16A.

FIG. 16E is a bottom view diagram that illustrates the expandable collet of FIG. 16A.

### DETAILED DESCRIPTION

The present disclosure describes abrasive rotary tools that feature an expandable collet for expanding an abrasive surface to improve contact with multi-planar edges of a substrate.

An abrasive rotary tool includes an abrasive surface for abrading a substrate. In some instances, the substrate may include one or more holes having edges that require abrading and polishing, such as cover glasses of electronics. To abrade a circular edge of a hole, the abrasive rotary tool may be placed within the hole and moved in a circular motion around the edge of the hole. To fit the abrasive rotary tool into the hole, the outer diameter of the abrasive rotary tool may be smaller than the inner diameter of the hole. Due to this smaller outer diameter of the abrasive rotary tool, the abrasive surface of the abrasive rotary tool may only contact a portion of the edge of the hole requiring extra process time for the tool to completely finish the whole circumference.

According to embodiments discussed herein, an abrasive rotary tool may include an expandable collet configured to expand an abrasive surface of the rotary tool radially from the rotary tool. For example, when abrading the edge of the hole described above, the abrasive rotary tool may be positioned in the hole when the expandable collet is in an unexpanded position in which an outer diameter of the expandable collet is smaller than the diameter of the hole, such as prior to insertion of a rod into the expandable collet. Once the abrasive rotary tool has been positioned in the hole, the rod may be inserted into the expandable collet and the expandable collet may expand into an expanded position. This expansion of the expandable collet causes the abrasive surface to expand and contact a greater portion of the edge of the hole than a nonexpanding abrasive rotary tool and with a more even force profile around the circumference of the hole. An elastic layer supporting the abrasive surface may allow the abrasive surface to continue to expand and exert a more consistent pressure from the abrasive surface as material is removed from the edge of the hole. In this way, an abrasive rotary tool may more quickly and/or evenly abrade an edge of a hole or other multi-planar surface.

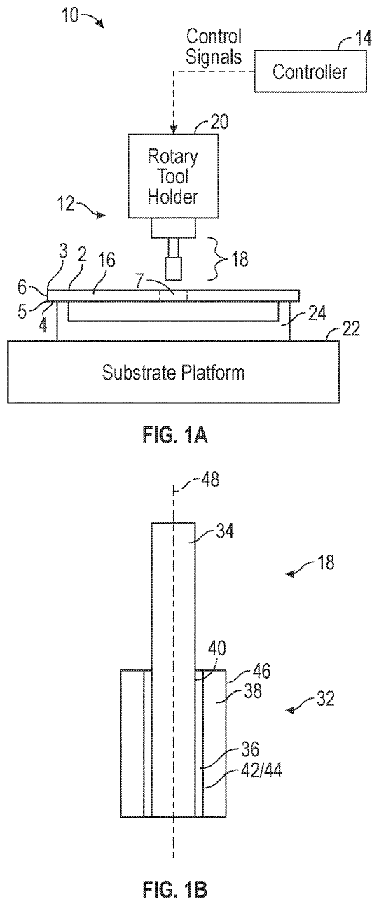

FIG. 1A illustrates an assembly 10, which includes a computer-controlled machining system 12 and a machining system controller 14. Controller 14 is configured to send control signals to machining system 12 for causing machining system 12 to machine, grind, or abrade a substrate 16 with a rotary tool 18, which is mounted within a rotary tool holder 20 of machining system 12. In one embodiment, machining system 12 may represent a CNC machine, such as a three, four, or five axis CNC machine, capable of performing routing, turning, drilling, milling, grinding, abrading, and/or other machining operations, and controller 14 may include a CNC controller that issues instructions to rotary tool holder 20 for performing machining, grinding, and/or abrading of substrate 16 with one or more rotary tools 18. Controller 14 may include a general-purpose computer running software, and such a computer may combine with a CNC controller to provide the functionality of controller 14.

Substrate 16 is mounted and secured to substrate platform 22 in a manner that facilitates precise machining of substrate 16 by machining system 12. Substrate holding fixture 24 secures substrate 16 to substrate platform 22 and precisely locates substrate 16 relative to machining system 12. Substrate holding fixture 24 may also provide a reference location for control programs of machining system 12. While the techniques disclosed herein may apply to workpieces of any materials, substrate 16 may be a component for an electronic device. In some embodiments, substrate 16 may be a display element, e.g., a transparent display element, of an electronic device, such as a cover glass for an electronic device or, more particularly, a cover glass of a smartphone touchscreen. For example, such cover glasses, back covers, or back housings may include holes having vertical side walls with chamfers for which a high degree of planarity and angularity is desired and access is limited due to the small cross-sectional area of the hole.

In some embodiments, substrate 16 may include a first major surface 2 (e.g. a top of substrate 16), a second major surface 4 (e.g. a bottom of substrate 16), one or more edge surfaces 6 (e.g. sides of substrate 16), and one or more holes 7 having an edge around a circumference of each of holes 7. The area of edge surface 6 of substrate 16 is typically less than the area of the first major surface and/or second major surface of substrate 16. In some embodiments, the ratio of edge surface 6 of substrate 16 to the area of first major surface 2 of substrate 16 and/or the ratio of edge surface 6 of substrate 16 to the area of second major surface 4 of substrate 16 may be greater than 0.00001, greater than 0.0001, greater than 0.0005, greater than 0.001, greater than 0.005 or even greater than 0.01; less than 0.1, less than 0.05 or even less than 0.02. In some embodiments, a thickness of edge surface 6 measured normal to first and/or second major surfaces 2, 4, is no greater than 15 mm, no greater than 4 mm, no greater than 3 mm, no greater than 2 mm or even no greater than 1 mm. Edge surface 6 intersects first major surface 2 to form a first corner 3 and intersects second major surface 4 to form the second corner 5. In some embodiments, edge surface 6 may be substantially perpendicular to each of major surfaces 2, 4, while in other examples, edge surface 6 may include more than one edge surface, wherein at least one of the more than one edge surfaces is not perpendicular (e.g., a chamfered edge, rounded edge, curved edge or combination of edge shapes).

In the embodiment of FIG. 1A, rotary tool 18 may be utilized to improve the surface finish of machined features of substrate 16, such as holes and edge features in a cover glass. In some embodiments, different rotary tools 18 may be used in series to iteratively improve the surface finish of the machined features. For example, assembly 10 may be utilized to provide a coarser grinding step using a first rotary tool 18, or a set of rotary tools 18, followed by a finer abrading step using a second rotary tool 18, or a set of rotary tools 18. In some embodiments, following grinding and/or abrading using assembly 10, a substrate may be polished, e.g., using a separate polishing system to further improve the surface finish. In general, the better the surface finish prior to polishing, the less time is required to provide a desired surface finish following the polishing. To abrade an edge of substrate 16 with assembly 10, controller 14 may issue instructions to rotary tool holder 20 to precisely apply an abrasive layer of a rotary tool 18 against one or more features of substrate 16 as rotary tool holder 20 rotates rotary tool 18. The instructions may include for example, instructions to precisely follow the contours of features of substrate 16 with a single abrasive rotary tool 18.

In accordance with embodiments discussed herein, abrasive rotary tool 18 is configured to improve contact of a working surface of abrasive rotary tool 18 with multi-planar surfaces of substrate 16. FIG. 1B is a side view cross-sectional diagram that illustrates abrasive rotary tool 18. Abrasive rotary tool 18 includes an abrasive article 32 and a rod 34 positioned in abrasive article 32. Abrasive article 32 includes an expandable collet 36 having an interior surface 40 and an exterior surface 42 and defining a longitudinal axis 48. Abrasive article 32 also includes an abrasive layer 38 having a working surface 46 and an opposed surface 44. Opposed surface 44 of abrasive article 32 is adjacent exterior surface 42 of expandable collet 36.

Rod 34 may define an axis of rotation (not shown) for abrasive rotary tool 18. Rod 34 may be configured to receive an applied force from a rotary tool holder, such as a rotational force around the axis of rotation of rod 34 and, optionally, a directional force along at least one of an x-, y-, or z-axis, and transmit at least a portion of the applied force to abrasive article 32. Abrasive article 32 may be configured to receive the applied force from rod 34, such as a rotational force around the axis of rotation of rod 34 and, optionally, a directional force along at least one of an x-, y-, or z-axis, and transmit at least a portion of the applied force to abrasive layer 38.

Expandable collet 36 has an unexpanded position prior to insertion of rod 34 and one or more expanded positions after insertion of rod 34. In an expanded position, expandable collet 36 exerts an inward radial force against rod 34 and an outward radial force against abrasive layer 38. The outward radial force, alone or in combination with other structural features of expandable collet 36 and/or rod 34, may assist in securing abrasive article 32 to rod 34. The outward radial force, alone or in combination with a support layer, may cause working surface 46 of abrasive layer 38 to expand and/or exert a greater amount or more even distribution of an abrasive force from working surface 46. As a result, abrasive rotary tool 18 may increase a surface area of working surface 46 that is in contact with the multi-planar surface of substrate 16, such as by more closely matching a curvature of working surface 46 to a curvature of the multi-planar surface of substrate 16, increase a consistency of abrasive force applied from working surface 46, such as by continuing to more closely match the curvature of working surface 46 to the curvature of the multi-planar surface of substrate 16 as material is removed from substrate 16, and/or increase a force exerted by working surface 46, such as by causing working surface 46 to expand and/or increasing a rigidity of working surface 46.

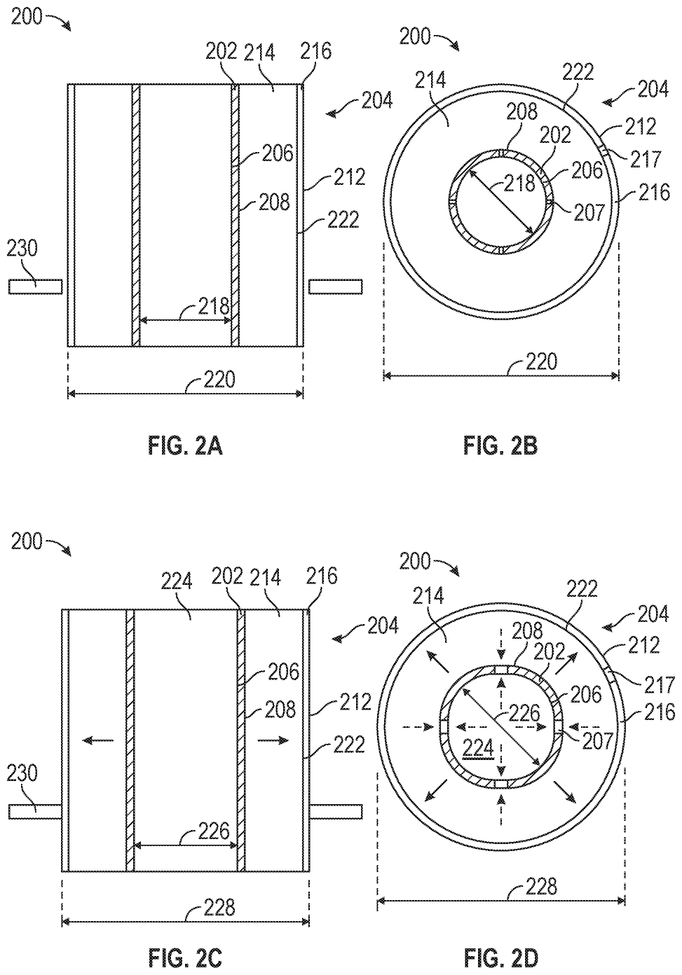

FIGS. 2A-2D illustrate an abrasive rotary tool 200 prior to insertion of a rod 224 into an expandable collet 202, corresponding to an unexpanded position of expandable collet 202, and after insertion of rod 224 into expandable collet 202, corresponding to an expanded position of expandable collet 202. FIG. 2A is a side view cross-sectional diagram and FIG. 2B is a top view diagram that illustrate an abrasive rotary tool 200 that includes an expandable collet 202 in an unexpanded position. FIG. 2C is a side view cross-sectional diagram and FIG. 2D is a top view diagram that illustrates abrasive rotary tool 200 that includes expandable collet 202 in an expanded position.

Abrasive rotary tool 200 includes abrasive article 204. Abrasive article 204 includes expandable collet 202 having an interior surface 206 and an exterior surface 208 and at least 2 expanding sections and defines a longitudinal axis. Abrasive article 204 includes an abrasive layer 216 having a working surface 212 and an opposed surface 222. Opposed surface 222 of abrasive layer 216 is adjacent exterior surface 208 of expandable collet 202. Abrasive article 204 includes an elastic layer 214 disposed between abrasive layer 216 and exterior surface 208 of expandable collet 202. Elastic layer 214 is capable of urging expandable collet 202 into the unexpanded position. In some examples, abrasive article 204 may include an adhesive layer (not shown) disposed between abrasive layer 216 and elastic layer 214.

When expandable collet 202 is in the unexpanded position, as shown in FIGS. 2A and 2B, interior surface 206 of expandable collet 202 defines an interior opening having a widest width dimension 218 and working surface 212 defines an outer diameter 220.

Abrasive article 204 may be placed into a hole of a substrate 230. As shown in FIG. 2A, outer diameter 220 of abrasive article 204 is less than an inner diameter of the hole in substrate 230, such that working surface 212 may not contact a full edge of substrate 230. In some examples, working surface 212 may contact a full edge of substrate 230 when expandable collet 202 is in the unexpanded position, but may do so with a low amount of outward radial force from working surface 212 compared to when expandable collet 202 is in the expanded position.

Rod 224 has a widest width dimension that is greater than widest width dimension 218 such that, when rod 224 is positioned in the interior opening of expandable collet 202, expandable collet 202 expands to the expanded position. When rod 224 is inserted into the interior opening of expandable collet 202 and expandable collet 202 is in the expanded position, as shown in FIGS. 2C and 2D, interior surface 206 of expandable collet 202 defines a widest width dimension 226 and working surface 212 defines an outer diameter 228. As shown in FIG. 2C, outer diameter 228 of abrasive article 204 is larger than the outer diameter of 212, such that working surface 212 may contact a greater portion of the edge of substrate 230. As a result, widest width dimension 226 of abrasive article 204 when expandable collet 202 is in the expanded position is greater than widest width dimension 218 of abrasive article 204 when expandable collet 202 is in the unexpanded position. In some examples, widest width dimension 226 is greater than widest width dimension 218 by at least about 0.5 millimeters.

As illustrated in FIG. 2D, as rod 224 is inserted into expandable collet 202, rod 224 exerts an outward radial force on expandable collet 202, such as indicated by outward radial dashed lines, forcing expandable collet 202 into the expanded position. This expansion force may be resisted by an opposing force from expandable collet 202, elastic layer 214 and/or abrasive layer 216, such as indicated by inward radial dashed lines, resisting any further outward radial expansion of expandable collet 202 and returning expandable collet 202 to an unexpanded position when rod 224 is removed.

Expandable collets discussed herein may be formed from a variety of materials including, but not limited to: plastics, such as polycarbonates, nylon, and acrylonitrile butadiene styrene (ABS); metals, such as stainless steel, aluminum, and brass: and the like. In some examples, the expandable collet may be formed from more than one material. For example, the expandable collet may have one or more segments of a first flexible and/or contoured material, such as a plastic, configured to contact an opposed surface of an abrasive layer and a second material, such as a metal, configured to couple the one or more segments of the first material.

Expandable collets discussed herein may be configured to expand a working surface of an abrasive rotary tool from an unexpanded diameter corresponding to an unexpanded position of the expandable collet to an expanded diameter corresponding to an expanded position of the expandable collet (an “expansion differential”). In some examples, the expansion differential of the working surface between the unexpanded position and the expanded position may be greater than about 0.1 millimeter, such as between about 0.2 millimeter and about five millimeters. In some examples, the expansion differential of the working surface may be a function of the expansion differential of the expandable collet. For example, a ratio of the expansion differential of the working surface to the expandable collet may be between about 1:2 (e.g., 5 mm to 10 mm) to about 1:100 (e.g., 0.1 mm to 10 mm). In some examples, the expansion differential of the expandable collet between the unexpanded position and the expanded position may be greater than 0.5 millimeters.

Expandable collets discussed herein have a variety of surface properties and dimensions that correspond to various properties and dimensions of a rod received by the expandable collet. In some examples, an interior surface of the expandable collet may include surface properties or features, such as surface roughness, surface contour, and friction coefficient, that are selected or configured to interface with surface properties or features of the rod. In some examples, an interior surface of the expandable collet may have surface dimensions, such as diameter, angle, or shape, that are configured to interface with or match surface dimensions of the rod. For example, an expandable collet may have an interior surface that, when a rod is received by the expandable collet, substantially contacts the exterior surface of the rod.

Expandable collets may have a variety of inner diameter across an interior surface and outer diameters across an exterior surface of the expandable collet. In some examples, an expandable collet may be configured to have an expanded inner diameter that corresponds to an outer diameter of a rod configured for insertion into expandable collet. In some examples, the expandable collet may have an inner diameter between about 2 mm and about 8 mm. In some examples, the expandable collet may have an unexpanded inner diameter that varies axially (e.g., tapers) along the expandable collet. For example, the expandable collet may have an unexpanded inner diameter at a proximal end that is substantially equal to an outer diameter of a rod and/or greater than an unexpanded inner diameter at a distal end. As such, the expandable collet may be configured to receive the rod through the proximal end and expand to the outer diameter of the rod at the distal end.

Expandable collets discussed herein may have an exterior surface configured to exert a substantially even force against an opposed surface of an abrasive layer, an elastic layer, an adhesive layer, or any other layer positioned adjacent to the exterior surface. For example, the expandable collet may have a sufficiently high and/or evenly distributed surface area of the exterior surface that a force exerted against the opposed surface is substantially even and, correspondingly, a force exerted by a working surface of the abrasive layer is substantially even. In some examples, a surface area of the exterior surface of the expandable collet is greater than about 50% of a surface area of the opposed surface of the abrasive layer.

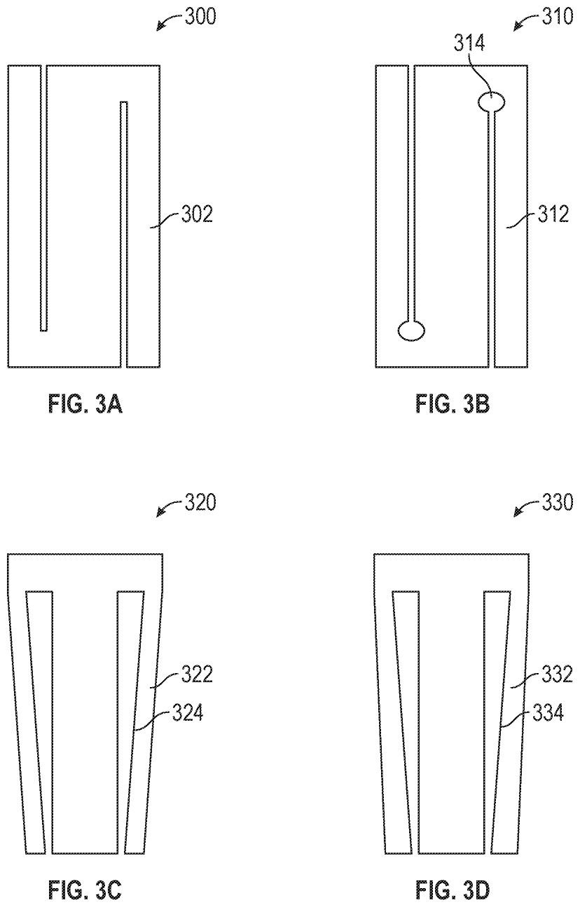

Expandable collets discussed herein may be configured to expand using one or more of a variety of mechanisms. In some examples, such as will be illustrated in FIGS. 3A-3D below, an expandable collet may include structural features that allow the expandable collet to expand in response to receiving an outward radial force on an interior surface of the expandable collet. For example, the interior surface may have partial or full discontinuities that form expandable segments or arms, such that the expandable segments or arms may separate in response to the outward radial force on the interior surface. In some examples, the expandable collet may be formed from materials that are elastic and allow the expandable collet to expand in response to receiving an outward radial force on the interior surface of the expandable collet.

FIG. 3A is a side view diagram that illustrates an expandable collet 300 with alternating segments 302. Alternating segments 302 may be configured to move radially away from a longitudinal axis of expandable collet 300. Due to alternating segments 302, expandable collet 300 may expand such that a radial force exerted from segments 302 is approximately equal at different axial positions of expandable collet 300. For example, a cylindrical rod positioned into expandable collet 300 may cause expandable collet 300 to expand such that a circumference of expandable collet 300 is substantially the same in an expanded position. As such, a force from a working surface of an abrasive layer around expandable collet 300 may be substantially the same at different axial positions on the working surface.

FIG. 3B is a side view diagram that illustrates an expandable collet 310 with alternating segments 312 and open joints 314 between segments 312. In addition to properties discussed above with respect to alternating segments 302, open joints 314 may increase a surface area of an intersection of alternative segments 312, such that segments 312 may bend less when expanded. For example, a cylindrical rod positioned into expandable collet 310 may cause expandable collet 310 to expand such that a circumference of expandable collet 310 is substantially the same in an expanded position. As such, a force from a working surface of an abrasive layer around expandable collet 310 may be substantially the same at different axial positions on the working surface.

FIG. 3C is a side view diagram that illustrates an expandable collet 320 with a plurality of arms 322 having a straight interior surface 324. The plurality of expandable arms 322 are configured to move radially away from a longitudinal axis of expandable collet 320. For example, a cylindrical rod positioned into expandable collet 320 may cause the plurality of arms 322 to expand radially such that a circumference of expandable collet 320 is substantially the same in an expanded position. In some examples, the plurality of expandable arms 322 comprises four or more expandable arms.

FIG. 3D is a side view diagram that illustrates an expandable collet 330 with a plurality of tapered arms 332 having a tapered interior surface 334. The plurality of expandable arms 332 are configured to move radially away from a longitudinal axis of expandable collet 330. For example, a tapered rod positioned into expandable collet 330 may cause the plurality of tapered arms 332 to expand radially such that a circumference of expandable collet 330 is substantially the same in an expanded position.

Abrasive rotary tools discussed herein may be configured for use with a variety of rod shapes and features. For example, the rod, alone or in combination with the expandable collet, may be configured to interface with the expandable collet to cause the abrasive rotary tool to expand in various ways and/or have various properties.

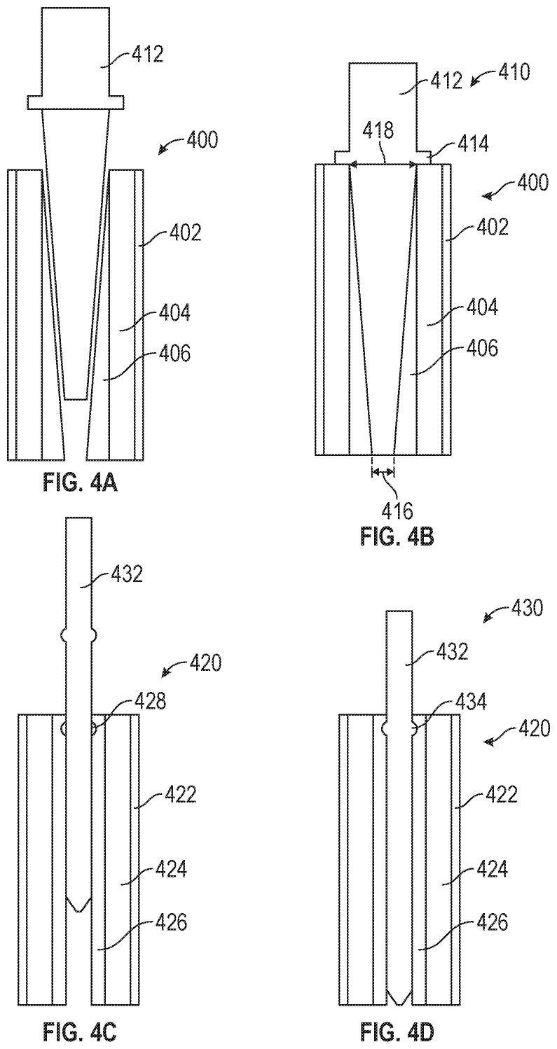

FIG. 4A is a side view cross-sectional diagram that illustrates an abrasive article 400 that includes an expandable collet 406 in an unexpanded position and configured to interface with a tapered rod. Abrasive article 400 includes an abrasive layer 402 and an elastic layer 404 between expandable collet 406 and abrasive layer 402. Expandable collet 406 may be configured to receive a tapered rod 412 such that a taper of expandable collet 406 may match a taper of tapered rod 412.

FIG. 4B is a side view cross-sectional diagram that illustrates an abrasive rotary tool 410 that includes abrasive article 400 of FIG. 4A and a tapered rod 412 inserted into abrasive article 400. Tapered rod 412 has a diameter 418 at a proximal end of abrasive article 400 greater than a diameter 416 at a distal end of abrasive article 400. As such, an interior opening of expandable collet 406 has a widest width dimension at the proximal end of the abrasive article 400. Rod 412 includes a limiting structure 414 configured to limit a distance in which rod 412 is inserted into expandable collet 406. For example, rod 412 may be inserted into abrasive article 400 until a proximal edge of abrasive article 400 abuts limiting structure 414.

FIG. 4C is a side view cross-sectional diagram that illustrates an abrasive article 420 that includes an expandable collet 426 in an unexpanded position and configured to interface with a cylindrical rod. Abrasive article 420 includes an abrasive layer 422 and an elastic layer 424 between expandable collet 426 and abrasive layer 422. An interior surface of expandable collet 426 may include a positioning feature 428. Expandable collet may be configured to receive a cylindrical rod 432 such that positioning feature 428 may match other features of cylindrical rod 432.

FIG. 4D is a side view cross-sectional diagram that illustrates an abrasive rotary tool that includes abrasive article 420 with expandable collet 426 in an expanded position around a cylindrical rod with a positioning structure 434. Positioning structure 434 of rod 432 may fit into positioning structure 428 of abrasive article 420, such that an axial position of abrasive article 420 with respect to rod 432 may be limited.

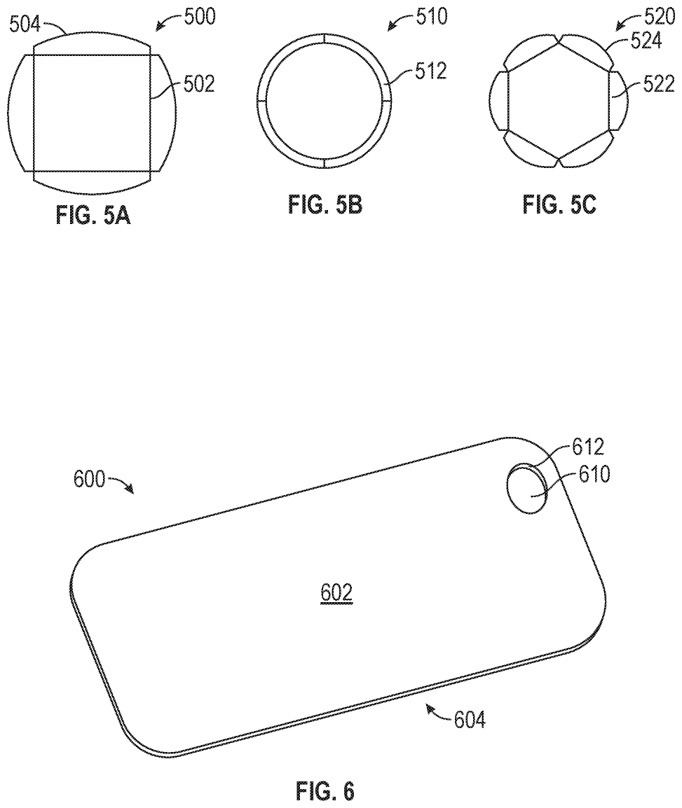

Rods of abrasive rotary tools discussed herein may have a variety of shapes that correspond to an interior surface of an expandable collet. In some examples, the rod has a cross-sectional shape perpendicular to the longitudinal axis comprising at least one of a square, a circle, or a hexagon. FIGS. 5A-5C illustrate various cross-sectional shapes of expandable collets configured for various shapes of rods. FIG. 5A is a bottom view diagram that illustrates an expandable collet 500 having a square cross-sectional shape. Expandable collet 500 include four planar expandable arms 502. FIG. 5B is a bottom view diagram that illustrates an expandable collet 510 having a circle cross-sectional shape. Expandable collet 510 includes four quarter-circle expandable arms 512. FIG. 5C is a bottom view diagram that illustrates an expandable collet 520 having a hexagon cross-sectional shape. Expandable collet 520 includes six planar expandable arms 522.

In some examples, rods used for abrasive rotary tools discussed herein may include one or more limiting structures configured to limit a position of the expandable collet with respect to the rod. For example, after a rod is inserted into the expandable collet, the limiting structures may limit an axial position of the expandable collet on the rod, a circumferential position of the expandable collet on the rod, and the like, such that the expandable collet may be secured at a particle axial or circumferential position on the rod. In some examples, the axial and/or rotational limiting structures discussed herein may further operate as alignment structures configured to align an expandable collet, and correspondingly an abrasive article, with an axial or circumferential position on the rod.

In some examples, rods discussed herein may include an axial limiting structure configured to limit an axial position of the expandable collet on the rod. The axial limiting structures may be configured to interface with one or more structures of the expandable collet to limit the axial position of the expandable collet on the rod. Axial limiting structures may include, but are not limited to, projections, stoppers, magnets, and other structures configured to interface with the expandable collet and provide at least some resistance to an axial directional force.

In some examples, rods discussed herein may include a rotational limiting structure configured to limit rotation and/or a circumferential position of the expandable collet on the rod. The rotational limiting structure may be configured to interface with one or more structures of the expandable collet to limit the circumferential position of the expandable collet on the rod. Rotational limiting structures may include, but are not limited to, noncircular rod shapes, projections, and other structures configured to interface with the expandable collet and provide at least some resistance to a rotational directional force.

Abrasive layers as discussed herein, such as abrasive layers 38 of FIG. 1B and 216 of FIGS. 2A-2D, include a working surface, such as working surfaces 46 and 212. The working surface is configured to contact and abrade one or more surfaces of a substrate. Abrading may include grinding, polishing, and any other action that removes material from the substrate. As will be appreciated by those skilled in the art, the working surface can be formed according to a variety of methods including, e.g., coating, molding, extruding, embossing, converting, adhering and combinations thereof.

In some examples, the working surfaces of abrasive layers discussed herein may be configured to expand in response to an expansion force exerted by the expandable collet, such as directly from an exterior surface or indirectly through an elastic layer, a rubber layer, an adhesive layer, or any other layer between the abrasive layer and the expandable collet. For example, abrasive layers may be formed from elastic materials that expand around a circumference of the abrasive rotary tool, such that a diameter of the abrasive rotary tool may increase.

The abrasive layer is not particularly limited and may include, but is not limited to, traditional coated abrasives and structured abrasives (e.g. 3M TRIZACT ABRASIVE, available from 3M Company, St. Paul, Minn.). The abrasive layer may include a base layer, e.g. backing layer, and a contact layer. The base layer may be formed from a polymeric material. For example, the base layer may be formed from thermoplastics, such as polypropylene, polyethylene, polyethylene terephthalate and the like; thermosets, such as polyurethanes, epoxy resin, and the like; or any combinations thereof. The base layer may include any number of layers. In some examples, the base layer may be an elastic base layer including, but not limited to, silicone rubber, neoprene rubber, viton, natural rubber, nitrile rubber, butyl rubber, timprene, synthetic rubber, sponge rubber, rigid and flexible PVC, thermoplastic elastomers (TPE), polyurethanes, latex rubber, and the like, such that the abrasive layer is capable of stretching in response to an expansion force on an opposing surface of the abrasive layer. The thickness of the base layer (i.e., the dimension of the base layer in a direction normal to the first and second major surfaces) may be less than 10 mm, less than 5 mm, less than 1 mm, less than 0.5 mm, less than 0.25 mm, less than 0.125 mm, or less than 0.05 mm.

In some embodiments, the working surface of the abrasive layer includes a microstructured surface. The microstructured surface may include microstructures configured to increase a contact pressure of the working surface on one or more surfaces of a substrate. In some embodiments, the microstructured surface may include a plurality of cavities interspaced between the outermost abrasive material of the abrasive layer. For example, the shape of the cavities may be selected from among a number of geometric shapes such as a cubic, cylindrical, prismatic, hemispherical, rectangular, pyramidal, truncated pyramidal, conical, truncated conical, cross, post-like with a bottom surface which is arcuate or flat, or combinations thereof Alternatively, some or all of the cavities may have an irregular shape. In various embodiments, one or more of the side or inner walls that form the cavities may be perpendicular relative to the top major surface or, alternatively, may be tapered in either direction (i.e., tapered toward the bottom of the cavity or toward the top of the cavity— toward the major surface). The angle forming the taper can range from about 1 to 75 degrees, from about 2 to 50 degrees, from about 3 to 35 degrees, or from between about 5 to 15 degrees. The height, or depth, of the cavities can be at least 1 micron, at least 10 micron, or at least 500 micron, or at least 1000 micron; less than 10 mm, less than 5 mm, or less than 1 mm. The height of the cavities may be the same, or one or more of the cavities may have a height that is different than any number of other cavities. In some embodiments, the cavities can be provided in an arrangement in which the cavities are in aligned rows and columns. In some instances, one or more rows of cavities can be directly aligned with an adjacent row of cavities. Alternatively, one or more rows of cavities can be offset from an adjacent row of cavities. In further embodiments, the cavities can be arranged in a spiral, helix, corkscrew, or lattice fashion. In still further embodiments, the composites can be deployed in a “random” array (i.e., not in an organized pattern).

In some embodiments, the microstructured surface of the working surface includes a plurality of precisely shaped abrasive composites. “Precisely shaped abrasive composite” refers to an abrasive composite having a molded shape that is the inverse of the mold cavity which is retained after the composite has been removed from the mold; preferably, the composite is substantially free of abrasive particles protruding beyond the exposed surfaces of the shape before the abrasive layer has been used, as described in U.S. Pat. No. 5,152,917 (Pieper et al.), which is incorporate herein by reference in its entirety. The plurality of precisely shaped abrasive composites may include a combination of abrasive particles and resin/binder forming a fixed abrasive. In some embodiments, the working surface may be formed as a two-dimensional abrasive material, such as an abrasive sheet with a layer of abrasive particles held to a backing by one or more resin or other binder layers. Alternatively, the working surface may be formed as a three-dimensional abrasive material, such as a resin or other binder layer that contains abrasive particles dispersed therein and is formed into a three-dimensional structure (forming a microstructured surface) via a molding or embossing process, for example, followed by curing, crosslinking, and/or crystallizing of the resin to solidify and maintain the three-dimensional structure. The three-dimensional structure may include a plurality of precisely shaped abrasive composites. In either embodiment, the working surface may include an abrasive composite which has appropriate height to allow for the abrasive composite to wear during use and/or dressing to expose a fresh layer of abrasive particles. The abrasive layer may comprise a three-dimensional, textured, flexible, fixed abrasive construction including a plurality of precisely shaped abrasive composites. The precisely shaped abrasive composites may be arranged in an array to form the three-dimensional, textured, flexible, fixed abrasive construction. The abrasive layer may comprise abrasive constructions that are patterned. Abrasive layers available under the trade designation TRIZACT patterned abrasive and TRIZACT diamond tile abrasives available from 3M Company, St. Paul, Minn., are exemplary patterned abrasives. Patterned abrasive layers include monolithic rows of abrasive composites precisely aligned and manufactured from a die, mold, or other techniques.

The shape of each precisely shaped abrasive composite may be selected for the particular application (e.g., workpiece material, working surface shape, working surface shape, temperature, resin phase material). The shape of each precisely shaped abrasive composite may be any useful shape, e.g., cubic, cylindrical, prismatic, right parallelepiped, pyramidal, truncated pyramidal, conical, hemispherical, truncated conical, cross, or post-like sections with a distal end. Composite pyramids may, for instance, have three, four sides, five sides, or six sides. The cross-sectional shape of the abrasive composite at the base may differ from the cross-sectional shape at the distal end. The transition between these shapes may be smooth and continuous or may occur in discrete steps. The precisely shaped abrasive composites may also have a mixture of different shapes. The precisely shaped abrasive composites may be arranged in rows, spiral, helix, or lattice fashion, or may be randomly placed. The precisely shaped abrasive composites may be arranged in a design meant to guide fluid flow and/or facilitate swarf removal.

The precisely shaped abrasive composites may be set out in a predetermined pattern or at a predetermined location within the abrasive layer. For example, when the abrasive layer is made by providing an abrasive/resin slurry between a backing and mold, the predetermined pattern of the precisely shaped abrasive composites will correspond to the pattern of the mold. The pattern is thus reproducible from abrasive layer to abrasive layer. The predetermined patterns may be in an array or arrangement, by which is meant that the composites are in a designed array such as aligned rows and columns, or alternating offset rows and columns. In another embodiment, the abrasive composites may be set out in a “random” array or pattern. By this is meant that the composites are not in a regular array of rows and columns as described above. It is understood, however, that this “random” array is a predetermined pattern in that the location of the precisely shaped abrasive composites is predetermined and corresponds to the mold.

An abrasive material forming the working surface of the abrasive layer may include a polymeric material, such as a resin. In some embodiments, the resin phase may include a cured or curable organic material. The method of curing is not critical, and may include, for instance, curing via energy such as UV light or heat. Examples of suitable resin phase materials include, for instance, amino resins, alkylated urea-formaldehyde resins, melamine-formaldehyde resins, alkylated benzoguanamine-formaldehyde resins, acrylate resins (including acrylates and methacrylates), phenolic resins, urethane resins, and epoxy resins.

Examples of suitable abrasive particles for the abrasive layer include cubic boron nitride, fused aluminum oxide, ceramic aluminum oxide, heat treated aluminum oxide, white fused aluminum oxide, black silicon carbide, green silicon carbide, titanium diboride, boron carbide, silicon nitride, tungsten carbide, titanium carbide, diamond, cubic boron nitride, hexagonal boron nitride, alumina zirconia, iron oxide, ceria, garnet, fused alumina zirconia, alumina-based sol gel derived abrasive particles and the like. The alumina abrasive particle may contain a metal oxide modifier. The diamond and cubic boron nitride abrasive particles may be mono crystalline or polycrystalline. Other examples of suitable inorganic abrasive particles include silica, iron oxide, chromia, ceria, zirconia, titania, tin oxide, gamma, alumina, and the like. The abrasive particles may be abrasive agglomerate particles. Abrasive agglomerate particles typically comprise a plurality of abrasive particles, a binder, and optional additives. The binder may be organic and/or inorganic. Abrasive agglomerates may be randomly shape or have a predetermined shape associated with them

In some embodiments, the abrasive layer, including resin, abrasive particles, and any additional additives dispersed in the resin, may be a coating on the expandable collet, elastic layer, or other layer contacting the abrasive layer. In some particular embodiments, an abrasive layer may be formed from an abrasive composite layer deposited on a base layer, the base layer may include a primer layer between the abrasive composite layer and the base layer. The base layer itself may be positioned over a backing layer, such as the expandable collet or elastic layer, with an adhesive securing the base layer to the backing layer.

In some examples, abrasive rotary tools discussed herein may include one or more elastic layers, such as elastic layer 214 of FIGS. 2A-2D, between the abrasive layer and the expandable collet. In some examples, the elastic layer may be configured to deform in response to a contact pressure of the abrasive article against a substrate. An elastic layer may deform by receiving a radial force, such as from the expandable collet, or other layer forming an interface with the elastic layer, and compressing in at least a portion of the elastic layer. In some examples, the elastic layer may be configured to exert a radial force against the abrasive layer and/or the expandable collet in response to receiving an expansion force from the expandable collet. For example, the expansion force from the expandable collet expanding into an expanded position may compress the elastic layer and cause the elastic layer to exert a corresponding force on the abrasive layer. Additionally or alternatively, the expansion force from the expandable collet expanding into the expanded position may cause the elastic layer to exert an opposite force against the expandable collet such that, when the rod is removed from the expandable collet, the expandable collet returns to the unexpanded position due at least in part to the opposite force exerted by the elastic layer.

In some embodiments, the compressibility of the elastic layer may be relatively high for operating conditions encountered during abrading. Compressibility may represent a measure of the relative change of a material of the elastic layer in response to a pressure, while the terms “compressible” or “incompressible” may refer to a material property of compressibility. For example, the term “substantially incompressible” refers to a material having a Poisson's ratio greater than about 0.45. Compressibility of a material may be expressed as a particular pressure required to compress the material to a reference deflection (e.g., 25% deflection). In some embodiments, the compressibility of the elastic layer may be measured via Compression Force Deflection Testing per ASTM D3574 or a modified version thereof, when the layer is foam; and via Compression-Deflection Testing per ASTM D1056 when the layer is a flexible cellular material such as, for example, sponge or expandable rubber. In some embodiments, the elastic layer may have a compressibility at 25% deflection of less than about 1.5 MPa (220 psi), less than about 1.1 MPa (160 psi), less than about 0.31 MPa (45 psi) and/or a Poisson's ratio less than about 0.5, less than about 0.4, less than 0.3 or preferably less than about 0.1.

In some embodiments, the elastic layer has a sufficiently high elasticity, such that the elastic layer compresses against the substrate under normal operating conditions. Elasticity (or stiffness) may represent a measure of the relative deformation (strain) of a material of the elastic layer in response to a pressure (stress), while the terms “elastic” or “inelastic” may refer to a material property of elasticity. For example, the term “substantially inelastic” refers to a material having a Poisson's ratio greater than about 0.45. Elasticity of a material may be expressed as a tensile modulus, Young's modulus, or elastic modulus. In some embodiments, the elasticity of the layer may be measured via Standard Test Method for Young's Modulus, Tangent Modulus, and Chord Modulus per ASTM E111-17. In some embodiments, the elastic layer may have a Young's Modulus of less than about 1.5 MPa (220 psi), less than about 1.1 MPa (160 psi), less than about 0.31 1VIPa (45 psi) and/or a Poisson's ratio less than about 0.5, less than about 0.4, less than 0.3 or preferably less than about 0.1. In some embodiments, the elastic layer comprises at least one of an elastomer, a fabric, a nonwoven material, or a spring.

In some embodiments, the elastic layer may be composed of a material selected according to relaxation modulus, e.g. stress relaxation modulus. Relaxation modulus may represent a measure of a time-dependent viscoelastic property. In this disclosure, relaxation modulus is expressed in percentage and is determined from the relaxation modulus versus time curve provided from a stress relaxation test (e.g., as measured using ASTM D6048) using the following equation:

Relaxation modulus (%)=(instantaneous modulus-modulus after 2 minutes relaxation under a constant compressive strain)/instantaneous modulus X 100. In some embodiments, the elastic layer has a relaxation modulus of less than 25%.

In some embodiments, the elastic layer may be configured for various thicknesses. For example, a thickness of the elastic layer may correlate with a force or distance of rebound of the elastic layer, such that the elastic layer may have a thickness that provides a particular range or distance of movement relative to the force produced or absorbed by the elastic layer. As an example, an elastic layer of an abrasive rotary tool intended for substrates with a relatively high degree of planarity may be thinner than an elastic layer of an abrasive rotary tool intended for substrates with a relatively low degree of planarity, as a higher degree of planarity may result in less compression or travel of the elastic layer. In some embodiments, the elastic layer thickness may be less than 5 mm, less than 4 mm, less than 3 mm, less than 2 mm, or less than 1 mm. The elastic layer may also be formed from a variety of materials having one or more properties discussed above. In some embodiments, the elastic layer includes at least one of an elastomer, a fabric, or a nonwoven material. Suitable elastomers may include thermoset elastomers such as, for example, nitriles, fluoroelastomers, chloroprenes, epichlorohydrins, silicones, urethanes, polyacrylates, EPDM (ethylene propylene diene monomer) rubbers, SBR (styrenebutadiene rubber), butyl rubbers, nylon, polystyrene, polyethylene, polypropylene, polyester, polyurethane, etc. In some embodiment, the density of the elastic layer may be greater than 0.2 g/cm³, greater than 0.4 g/cm³, greater than 0.6 g/cm³, greater than 0.8 g/cm³, greater than 0.85 g/cm³, greater than 0.9 g/cm³, greater than 0.95 g/cm³, greater than 1.0 g/cm³, greater than 1.1 g/cm³ or even greater than 1.2 g/cm³; less than 2.0 g/cm³, less than 1.8 g/cm³, less than 1.6 g/cm³, less than 1.4 g/cm³ or even less than 1.2 g/cm³.

In some examples, the elastic layer may have varying thickness. For example, a cylindrical abrasive rotary tool with a tapered expandable collet configured to receive a tapered rod may have an elastic layer with a higher thickness at a distal end than at a proximal end such that the abrasive rotary tool is cylindrical when the expandable collet is in the expanded position.

In various embodiments, abrasive rotary tools as described herein may be suitable for edge or major surface grinding a cover glass. For example, a cover glass may include various interior surfaces, such as edges of holes, that may be relatively difficult to abrade. FIG. 6 illustrates a cover glass for an electronic device such as a cellular phone, personal music player, or other electronic device. In some embodiments, cover glass 600 may be a component of a touchscreen for the electronic device. Cover glass 600 may be an alumina-silicate based glass with a thickness of less than 1 mm, although other compositions are also possible, such as a thickness of less than 5 mm, less than 4 mm, less than 3 mm or even less than 2 mm.

Cover glass 600 includes a first major surface 602 opposing a second major surface 604. Generally, but not always, major surfaces 602, 604 are planar surfaces. Cover glass 600 also includes a hole 610 having an edge surface 612.

To provide an increased resistance to cracking and improved appearance, abrasive rotary tools may be used to reduce edge surface roughness, such as edge surface 612 of hole 610 and corners 608 using a CNC machine prior. An abrasive rotary tool with an expandable collet configured to expand an outer diameter of an abrasive layer may more quickly and/or consistently abrade edge surface 612, as a greater surface area of the abrasive layer may contact edge surface 612.

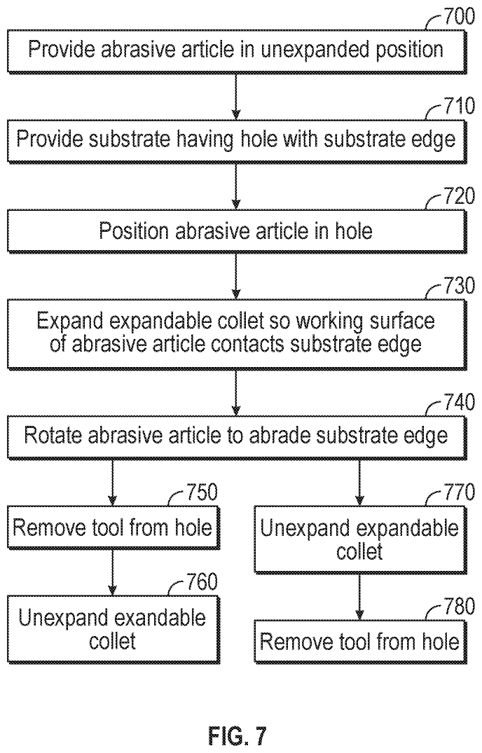

FIG. 7 is a flowchart illustrating exemplary techniques for abrading a substrate. While the techniques of FIG. 7 will be described with reference to an operator manipulating assembly 10 of FIG. 1A, other assemblies and agents of operation may be used. The operator provides computer-controlled machining system 12, which includes computer controlled rotary tool holder 20 and substrate platform 22. The operator provides abrasive article 32 in which expandable collet 36 is in the unexpanded position (700). The operator provides substrate 16 having hole 7 in which a first substrate edge defines the circumference of hole 7 (710). The operator positions the abrasive article into the at least one hole (720). The operator expands expandable collet 36 such that working surface 46 of abrasive article 32 contacts the first substrate edge (730). The operator rotates abrasive article 32 around longitudinal axis 48, thereby abrading the first substrate edge (740). In some examples, working surface 46 contacts at least 50% of the first substrate edge around the circumference of hole 7. For example, the operator may expand expandable collet 36 by positioning rod 34 in the interior opening of expandable collet 36, thereby urging expandable collet 36 to the expanded position.

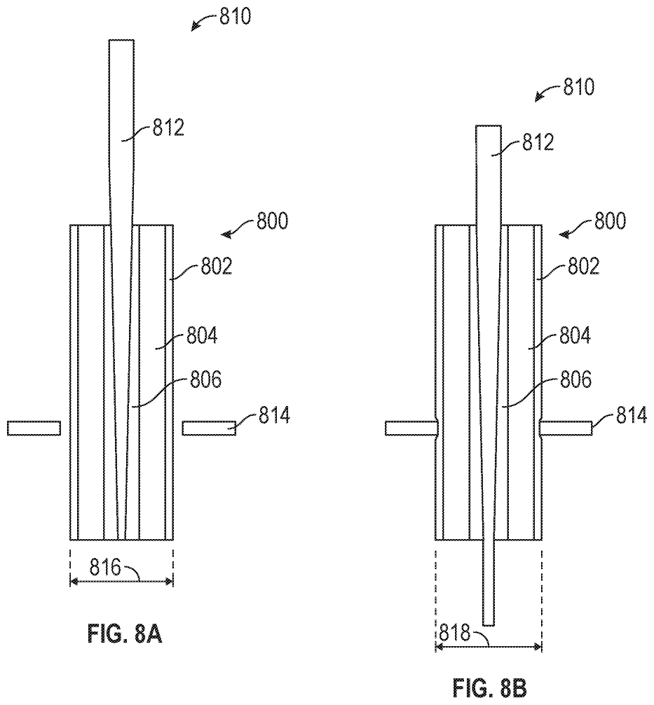

In some examples, abrasive rotary tools discussed herein may be configured to have expanded positions that correspond to different outer diameters and vary based on an axial position of a rod within an expandable collet. For example, an abrasive rotary tool with more than one expanded position may be used for different sized holes or edges with different radii. FIGS. 8A and 8B illustrate an abrasive rotary tool that includes an expandable collet configured to expand to more than one outer diameter. FIG. 8A is a side view cross-sectional diagram that illustrates an abrasive rotary tool 810 that includes an expandable collet 806 in a first expanded position, while FIG. 8B is a side view cross-sectional diagram that illustrates abrasive rotary tool 810 that includes expandable collet 806 in a second expanded position. Abrasive rotary tool 810 includes abrasive article 800 and tapered rod 812. Tapered rod 812 has a diameter at a proximal end of abrasive article 800 that is greater than a diameter at a distal end of abrasive article 800, while an interior opening of expandable collet 806 has widest width dimension at the proximal end of abrasive article 800. Abrasive article 800 includes an abrasive layer 802 and an elastic layer 804 between expandable collet 806 and abrasive layer 802.

As shown in FIG. 8A, tapered rod 812 may be inserted into expandable collet 806 to a first axial position corresponding to a first expanded position having a first widest width dimension 816. In the example of FIG. 8A, the first widest width dimension 816 may be less than a widest width dimension of a hole of a substrate 814, such that abrasive layer 802 may not contact a whole surface of substrate 814.

As shown in FIG. 8B, tapered rod 812 may be inserted into expandable collet 806 to a second axial position corresponding to a second expanded position having a second widest width dimension 818 that is greater than first widest width dimension of the first expanded position. In the example of FIG. 8B, the second widest width dimension 818 may be at least the widest width dimension of the hole of substrate 814, such that abrasive layer 802 may contact a greater amount of surface area of the hole and/or exert a greater amount of force on the surface of the hole.

Abrasive rotary tools that include more than one expanded position may be used for a variety of hole sizes, such as holes that have different desired width dimensions or holes that have width dimensions that expand from material removal. For example, a first hole may have first widest width dimension and a second hole may have a second widest width dimension that is different from the first widest width dimension. As such, for the first hole, expanding expandable collet 806 may include positioning rod 812 in an interior opening at the first expanded position when abrasive article 800 is positioned in the first hole. For the second hole, expanding expandable collet 806 may include positioning rod 812 in the interior opening at the second expanded position.

Select embodiments of the present disclosure include, but are not limited to, the following:

In a first embodiment, the present disclosure provides an abrasive article, comprising:

an expandable collet having an interior surface and an exterior surface defining a longitudinal axis, wherein the expandable collet has an unexpanded position and an expanded position, and wherein the interior surface defines an interior opening having a widest width dimension, Di, when the expandable collet in the unexpanded position; and an abrasive layer having a working surface and an opposed surface, wherein the opposed surface of the abrasive assembly is adjacent the exterior surface of the expandable collet.

In a second embodiment, the present disclosure provides an abrasive article according to the first embodiment, wherein the expandable collet is in the unexpanded position.

In a third embodiment, the present disclosure provides an abrasive article according to the first embodiment, wherein the expandable collet is in the expanded position.

In a fourth embodiment, the present disclosure provides an abrasive article according to any of the first through third embodiments, wherein the abrasive assembly further comprises an elastic layer disposed between the abrasive layer and the exterior surface of the expandable collet.

In a fifth embodiment, the present disclosure provides an abrasive article according to the fourth embodiment, wherein the elastic layer is capable of urging the expandable collet into the unexpanded position.

In a sixth embodiment, the present disclosure provides an abrasive article according to the fourth embodiment, wherein the abrasive article further comprises an adhesive layer disposed between the abrasive layer and the elastic layer.

In a seventh embodiment, the present disclosure provides an abrasive article according to any of the first through sixth embodiments, further comprising a rod, wherein the rod is capable of urging the expandable collet into the expanded position.

In an eighth embodiment, the present disclosure provides an abrasive article according to any of the fourth through seventh embodiments,
wherein the rod has a widest width dimension, Dr, wherein Dr >Di,
wherein the rod is positioned in the interior opening of the expandable collet, and
wherein the expandable collet is in the expanded position.

In a ninth embodiment, the present disclosure provides an abrasive article according to any of the fourth through eighth embodiments, wherein the rod has a cross-sectional shape perpendicular to the longitudinal axis comprising at least one of a square, a circle, or a hexagon.

In a tenth embodiment, the present disclosure provides an abrasive article according to any of the first through ninth embodiments, wherein the rod has a diameter at a proximal end of the abrasive article greater than a diameter at a distal end of the abrasive article, and wherein the interior opening has the widest width dimension, Di, at the proximal end of the abrasive article.

In an eleventh embodiment, the present disclosure provides an abrasive article according to any of the first through tenth embodiments, wherein a surface area of the exterior surface of the expandable collet is greater than about 50% of a surface area of the opposed surface of the abrasive layer.

In a twelfth embodiment, the present disclosure provides an abrasive article according to any of the first through eleventh embodiments, wherein the expandable collet comprises a plurality of expandable arms configured to move radially away from the longitudinal axis.

In a thirteenth embodiment, the present disclosure provides an abrasive article according to the twelfth embodiment, wherein the plurality of expandable arms comprises four or more expandable arms.

In a fourteenth embodiment, the present disclosure provides an abrasive article according to any of the first through thirteenth embodiments, wherein a widest width dimension, De, of the abrasive article when the expandable collet is in the expanded position is greater than a widest width dimension, Du, of the abrasive article when the expandable collet is in the unexpanded position.

In a fifteenth embodiment, the present disclosure provides an abrasive article according to the fourteenth embodiment, wherein De is greater than Du by at least about 0.5 millimeters.

In a sixteenth embodiment, the present disclosure provides a method for abrading a substrate, comprising:
providing an abrasive article according to claim 1, wherein the expandable collet is in the unexpanded position;
providing the substrate having at least one hole, wherein a first substrate edge defines the circumference of the at least one hole;
positioning the abrasive article into the at least one hole;
expanding the expandable collet such that the working surface of the abrasive article contacts the first substrate edge;
rotating the abrasive article around the longitudinal axis, thereby abrading the first substrate edge.

In a seventeenth embodiment, the present disclosure provides a method according to the sixteenth embodiment, wherein the working surface contacts at least 50% of the first substrate edge around the circumference of the at least one hole.

In an eighteenth embodiment, the present disclosure provides a method according to the sixteenth or seventeenth embodiment, wherein expanding the expandable collet comprises positioning a rod in the interior opening of the expandable collet, thereby urging the expandable collet to the expanded position.

In a nineteenth embodiment, the present disclosure provides a method according to the eighteenth embodiment, wherein the rod has a widest width dimension, Dr, wherein Dr >Di.

In a twentieth embodiment, the present disclosure provides a method according to the nineteenth embodiment,
wherein the rod has a diameter at a proximal end of the abrasive article greater than a rod diameter at a distal end of the abrasive article,
wherein the interior opening has the widest width dimension, Di, at the proximal end of the abrasive article,
wherein the at least one hole comprises a first hole having a first widest width dimension and a second hole having a second widest width dimension, different from the first widest width dimension, and
wherein expanding the expandable collet further comprises:
positioning the rod in the interior opening at a first position when the abrasive article is positioned in the first hole; and
positioning the rod in the interior opening at a second position, different from the
first position, when the abrasive article is positioned in the second hole.

### Examples

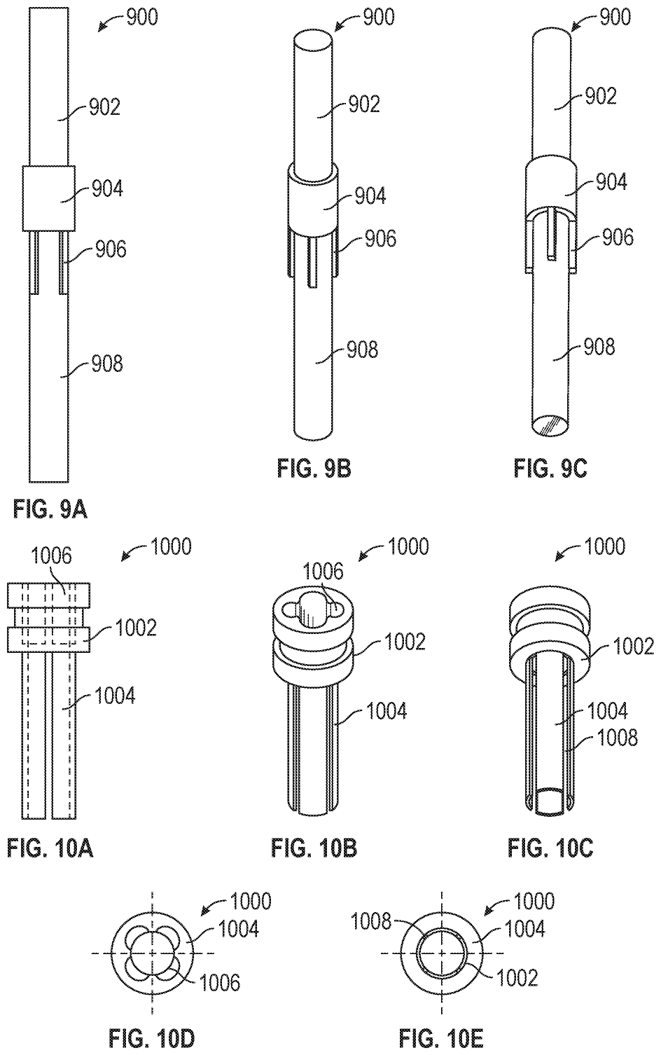

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure. FIGS. 9A-16E are diagrams of various configurations of rotary tools as disclosed herein.

FIG. 9A is a side view diagram of a rod 900 for an abrasive rotary tool that includes an expandable collet, while FIGS. 9B and 9C are perspective view diagrams that illustrates the rod of FIG. 9A. Rod 900 includes a proximal portion 902 for securing to an abrasive rotary tool holder, such as rotary tool holder 20 of FIG. 1A, and a distal portion 908 for positioning in an abrasive article that includes the expandable collet. Rod 900 includes an axial limiting structure 904 for limiting an axial position of the abrasive article on rod 900. Rod 900 also includes a plurality of rotational limiting structures 906 for interfacing with the abrasive article and preventing rotation of distal portion 908 of rod 900 within the abrasive article.

FIG. 10A is a side view diagram that illustrates an expandable collet 1000, while FIGS. 10B and 10C are perspective view diagrams, FIG. 10D is a top view diagram, and FIG. 10E is a bottom view diagram that illustrate expandable collet 1000 of FIG. 10A. Expandable collet 1000 includes a plurality of expandable arms 1004 configured to expand in response to a rod, such as rod 900 of FIGS. 9A-9C, positioned within expandable collet 1000. Expandable collet 1000 includes an axial limiting structure 1002 for limiting an axial position of expandable collet 1000 on a rod, such as by interfacing with axial limiting structure 904 of rod 900 when rod 900 is inserted into expandable collet 1000. Expandable collet also includes a plurality of rotational limiting structures 1006 for interfacing with the rod, such as rotational limiting structures 906 of rod 900, and prevent rotation of distal portion 908 of rod 900 within expandable collet 1000.

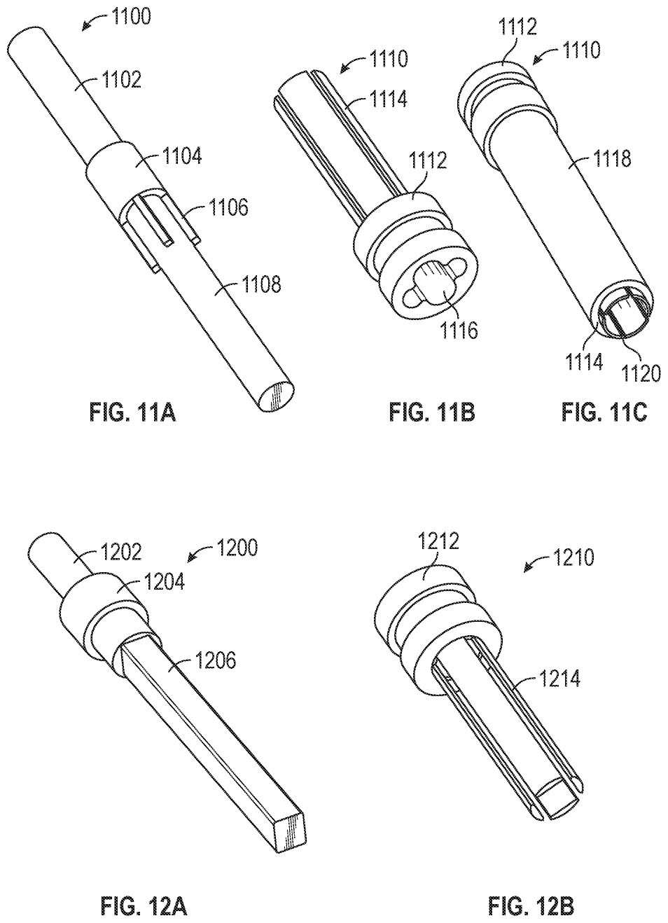

FIG. 11A is a perspective view diagram that illustrates a rod 1100 for an abrasive rotary tool that includes an expandable collet 1110, while FIG. 11B is a perspective view diagram that illustrates expandable collet 1110 for receiving rod 1100 of FIG. 11A. A proximal portion 1102, an axial limiting structure 1104, rotational limiting structures 1106, and a distal portion 1108 of rod 1100 may correspond to proximal portion 902, axial limiting structure 904, rotational limiting structures 906, and distal portion 908 of rod 900 of FIGS. 9A-9C, while expandable arms 1114, an axial limiting structure 1112, and rotational limiting structures 1116 of expandable collet 1110 may correspond to expandable arms 1004, axial limiting structure 102, and rotational limiting structures 1006 of expandable collet 1000 of FIGS. 10A-10E. FIG. 11C is a perspective diagram of expandable collet 1110 of FIG. 11B that includes an abrasive layer 1118. Abrasive layer 1118 is adjacent to expandable arms 1114 of expandable collet 1110.

Example 1 is illustrated in FIGS. 11A, B and C. 11 A and B were made from 3D printing, with SLA 3D printing machine, from a CAD drawing. The abrasive layer 1118 in FIG. 11C includes a sublayer made of an elastic layer from Fisher Scientific, Pittsburgh, Pa., Catalog No. 14-178-2B. On the outer surface of the elastic layer is a layer of 3M abrasive 578XA commercially available from 3M Company, St. Paul, Minn. The 578XA abrasive is supplied with adhesive that is adhered to the elastic layer. The abrasive is cut to shape and applied to the outer circumference of the elastic layer. The overall length is 3.5″ and diameter is 7/16″

FIG. 12A is a perspective view diagram that illustrates a rod 1200 for an abrasive rotary tool that includes an expandable collet 1210, while FIG. 12B is a perspective view diagram that illustrates expandable collet 1210 for receiving rod 1200 of FIG. 12A. Rod 1200 includes a proximal portion 1202 for securing to an abrasive rotary tool holder, such as rotary tool holder 20 of FIG. 1A, and a distal portion 1206 for positioning in an abrasive article that includes the expandable collet. Rod 1200 includes an axial limiting structure 1204 for limiting an axial position of the abrasive article on rod 1200. Distal portion 1206 of rod 1200 has a square shape that includes a plurality of corners for interfacing with the abrasive article and preventing rotation of distal portion 1206 of rod 1200 within the abrasive article. Expandable collet 1210 includes a plurality of expandable arms 1214 configured to expand in response to rod 1200 positioned within expandable collet 1210. Expandable collet 1210 includes an axial limiting structure 1212 for limiting an axial position of expandable collet 1210 on rod 1200, such as by interfacing with axial limiting structure 1204 of rod 1200 when rod 1200 is inserted into expandable collet 1210. An interior surface of expandable collet 1210 has a square shape that includes a plurality of corners for interfacing with the square corners of rod 1200 and preventing rotation of distal portion 1206 of rod 1200 within expandable collet 1210.

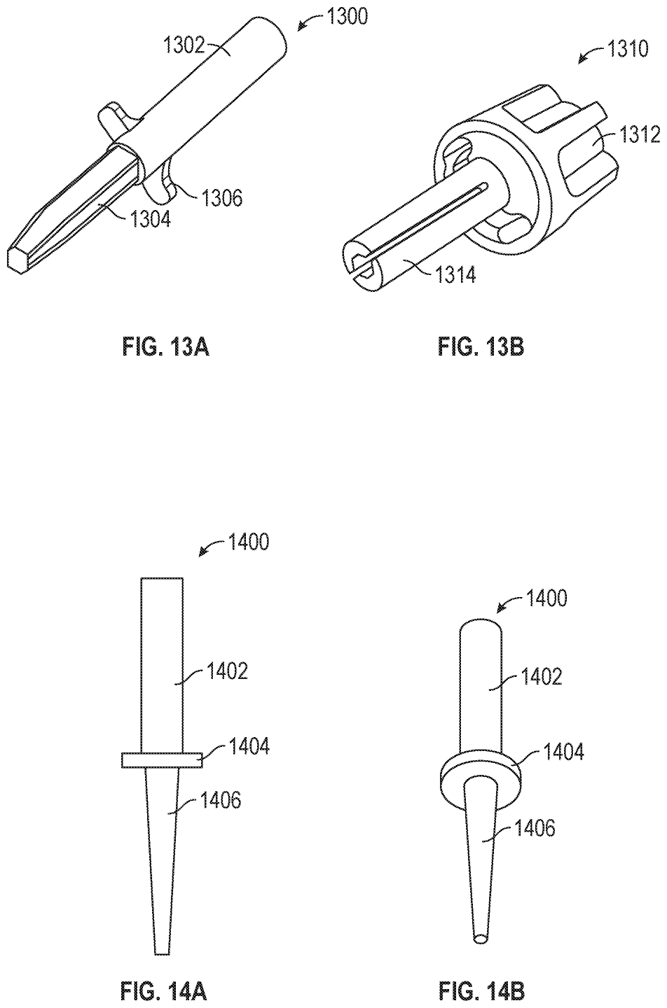

FIG. 13A is a perspective view diagram that illustrates a rod 1300 for an abrasive rotary tool that includes an expandable collet 1310, while FIG. 13B is a perspective view diagram that illustrates expandable collet 1310 for receiving rod 1300 of FIG. 13A. Rod 1300 includes a proximal portion 1302 for securing to an abrasive rotary tool holder, such as rotary tool holder 20 of FIG. 1A, and a distal portion 1304 for positioning in an abrasive article that includes expandable collet 1310. Distal portion 1304 has a tapered shape, such that a tip of distal portion 1304 may be inserted into a small diameter opening of expandable collet 1310. Rod 1300 includes an axial and rotational limiting structure 1306 for limiting an axial and rotational position of the abrasive article on rod 1300. Expandable collet 1310 includes a plurality of expandable arms 1314 configured to expand in response to rod 1300 positioned within expandable collet 1310. Expandable collet 1310 includes an axial and rotational limiting structure 1312 for limiting an axial and circumferential position of expandable collet 1310 on rod 1300, such as by interfacing with axial and rotational limiting structure 1306 of rod 1300 when rod 1300 is inserted into expandable collet 1310.

FIG. 14A is a side view diagram that illustrates a rod 1400 for an abrasive rotary tool that includes an expandable collet, while FIG. 14B is a perspective view diagram that illustrates rod 1400 of FIG. 14A. Rod 900 includes a proximal portion 1402 for securing to an abrasive rotary tool holder, such as rotary tool holder 20 of FIG. 1A, and a distal portion 1406 for positioning an abrasive article that includes the expandable collet. Rod 1400 includes an axial limiting structure 1404 for limiting an axial position of the abrasive article on rod 900.

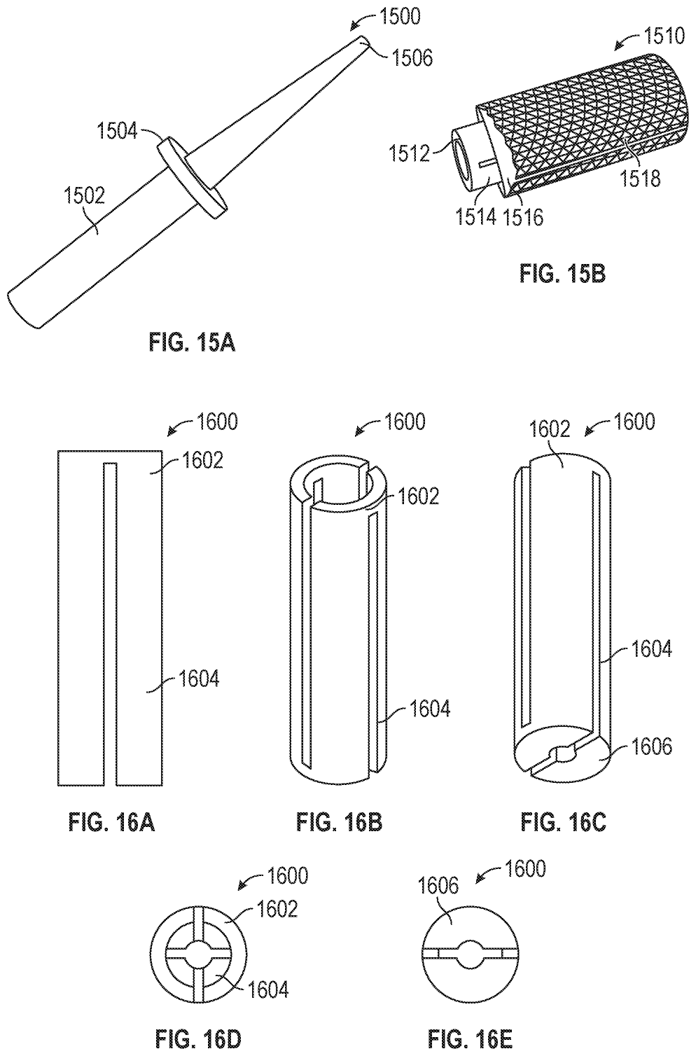

FIG. 15A is a perspective view diagram that illustrates a rod 1500 for an abrasive rotary tool that includes an expandable collet 1512, while FIG. 15B is a perspective view diagram that illustrates an abrasive article 1510 that includes expandable collet 1512 with an abrasive layer 1518 for receiving rod 1500 of FIG. 15A. A proximal portion 1502, an axial limiting structure 1504, and a distal portion 1506 of rod 1500 may correspond to proximal portion 1402, axial limiting structure 1404, and distal portion 1406 of rod 1400 of FIGS. 14A-14B. Expandable collet 1512 includes a plurality of expandable arms 1514 configured to expand in response to rod 1500 positioned within expandable collet 1512. Abrasive article 1510 includes an elastic layer 1516 and abrasive layer 1518. Abrasive layer 1518 is adjacent to expandable arms 1514 of expandable collet 1512.

Example 2 is illustrated in FIG. 15. Rod 1500 and expanding collet 1512 were made from 3D printing, with SLA 3D printing machine, from a CAD drawing. Abrasive article includes an elastic layer 1516 from Fisher Scientific, Pittsburgh, Pa., Catalog No. 14-178-2B. and abrasive layer 1518 known as 578XA commercially available from 3M Company, St. Paul, Minn. The 578XA abrasive is supplied with adhesive that is adhered to the elastic layer. The abrasive is cut to shape and applied to the outer circumference of the elastic layer. The overall length is 3.5″ and diameter is 7/16″

FIG. 16A is a side view diagram that illustrates an expandable collet 1600, while FIGS. 16B and 16C are perspective view diagrams, FIG. 16D is a top view diagram, and FIG. 16E is a bottom view diagram that illustrates expandable collet 1600 of FIG. 16A. Expandable collet 1600 includes a plurality of expandable segments 1604 configured to expand in response to a rod positioned within expandable collet 1600. Expandable segments 1604 are connected at a proximal portion 1602 and a distal portion 1606 of expandable collet 1600.

Various embodiments of the invention have been described. These and other embodiments are within the scope of the following claims.

1. An abrasive article comprising:
an expandable collet having an interior surface and an exterior surface defining a longitudinal axis, wherein the expandable collet has an unexpanded position and an expanded position, and wherein the interior surface defines an interior opening having a widest width dimension, Di, when the expandable collet in the unexpanded position; and
an abrasive layer having a working surface and an opposed surface, wherein the opposed surface of the abrasive article is adjacent the exterior surface of the expandable collet.

2. The abrasive article of claim 1, wherein the expandable collet is in the unexpanded position.

3. The abrasive article of claim 1, wherein the expandable collet is in the expanded position.

4. The abrasive article of claim 1, wherein the abrasive article further comprises an elastic layer disposed between the abrasive layer and the exterior surface of the expandable collet.

5. The abrasive article of claim 4, wherein the elastic layer is capable of urging the expandable collet into the unexpanded position.

6. The abrasive article of claim 4, wherein the abrasive article further comprises an adhesive layer disposed between the abrasive layer and the elastic layer.

7. The abrasive article of claim 1, further comprising a rod, wherein the rod is capable of urging the expandable collet into the expanded position.

8. The abrasive article of claim 7,
wherein the rod has a widest width dimension, Dr, wherein Dr >Di,
wherein the rod is positioned in the interior opening of the expandable collet, and
wherein the expandable collet is in the expanded position.

9. The abrasive article of claim 8, wherein the rod has a cross-sectional shape perpendicular to the longitudinal axis comprising at least one of a square, a circle, or a hexagon.

10. The abrasive article of claim 7,
wherein the rod has a diameter at a proximal end of the abrasive article greater than a diameter at a distal end of the abrasive article, and
wherein the interior opening has the widest width dimension, Di, at the proximal end of the abrasive article.

11. The abrasive article of claim 1, wherein a surface area of the exterior surface of the expandable collet is greater than about 50% of a surface area of the opposed surface of the abrasive layer.

12. The abrasive article of claim 1, wherein the expandable collet comprises a plurality of expandable arms configured to move radially away from the longitudinal axis.

13. The abrasive article of claim 12, wherein the plurality of expandable arms comprises four or more expandable arms.

14. The abrasive article of claim 1, wherein a widest width dimension, De, of the abrasive article when the expandable collet is in the expanded position is greater than a widest width dimension, Du, of the abrasive article when the expandable collet is in the unexpanded position.

15. The abrasive article of claim 14, wherein De is greater than Du by at least about 0.5 millimeters.

16. A method of abrading a substrate comprising:
providing an abrasive article according to claim 1, wherein the expandable collet is in the unexpanded position;
providing the substrate having at least one hole, wherein a first substrate edge defines a circumference of the at least one hole;
positioning the abrasive article into the at least one hole;
expanding the expandable collet such that the working surface of the abrasive article contacts the first substrate edge;
rotating the abrasive article around the longitudinal axis, thereby abrading the first substrate edge.

17. The method of claim 16, wherein the working surface contacts at least 50% of the first substrate edge around the circumference of the at least one hole.

18. The method of claim 16, wherein expanding the expandable collet comprises positioning a rod in the interior opening of the expandable collet, thereby urging the expandable collet to the expanded position.

19. The method of claim 18, wherein the rod has a widest width dimension, Dr, wherein Dr >Di.

20. The method of claim 18,
wherein the rod has a diameter at a proximal end of the abrasive article greater than a rod diameter at a distal end of the abrasive article,
wherein the interior opening has the widest width dimension, Di, at the proximal end of the abrasive article,
wherein the at least one hole comprises a first hole having a first widest width dimension and a second hole having a second widest width dimension, different from the first widest width dimension, and
wherein expanding the expandable collet further comprises:
positioning the rod in the interior opening at a first position when the abrasive article is positioned in the first hole; and
positioning the rod in the interior opening at a second position, different from the first position, when the abrasive article is positioned in the second hole.
